(19) United States
(12) Patent Application Publication
(10) Pub. No.: US 2020/0249360 A1
(43) Pub. Date: Aug. 6, 2020

(54) EMERGENCY SAFETY AND SURVIVAL KIT

(71) Applicant: Thomas A. Majercak, Knoxville, TN (US)

(72) Inventor: Thomas A. Majercak, Knoxville, TN (US)

(21) Appl. No.: 16/265,153

(22) Filed: Feb. 1, 2019

(51) Int. Cl. G01S 19/17; H02J 7/35; H02S 40/38; G01S 19/34

(52) U.S. Cl. CPC G01S 19/17; H02J 7/35; F21L 4/00; G01S 19/34; H02S 40/38

(57) ABSTRACT

An emergency safety and survival device and system, including a processing unit configured to provide a GPS location of a user, the processing unit including a source of electrical power to provide a source of electrical power to the processing unit and one or more external devices, a storage housing removably attachable to the processing unit, the storage housing being configured to store one or more survival tools therein, and an attachment device connected to the processing unit such that the processing unit is removably attachable to the user's body.

### FIELD OF INVENTIVE CONCEPT

The present general inventive concept relates to an emergency safety and survival device and system, and more particularly to a device wearable by a user to provide the user and/or others in communication with the user with an assortment of tracking, survival, power, and communication tools to aid the user in case of an emergency, the available tools being based on the nature of the activity being performed.

### BACKGROUND

Improvement is desired in regard to emergency communication and survival devices designed to enhance the safety and security of users while they participate in various activities such as hiking, climbing, boating, travel, and/or any other outdoor or adventurous activity. In particular, improvement is desired in regard to the convenience, portability, assortment, applicability, and accessibility of such devices so as to enhance the safety of capabilities of users during various types of emergencies, such as becoming lost, having damaged equipment, losing power, enduring difficult weather conditions, losing communication signals, and/or other potentially dangerous or life-threatening events occurring during various types of activities, especially various outdoor adventurous activities.

### BRIEF SUMMARY

Example embodiments of the present general inventive concept provide an emergency device, including comprising a processing unit configured to provide a GPS location of a user, the processing unit including a source of electrical power to provide a source of electrical power to the processing unit and one or more external devices, a storage housing removably attachable to the processing unit, the storage housing being configured to store one or more survival tools therein, and an attachment device connected to the processing unit such that the processing unit is removably attachable to the user's body.

Example embodiments of the present general inventive concept also provide an emergency kit, including a GPS receiver configured to receive location information from multiple GPS satellites and calculate location of the GPS receiver based on a distance from the GPS satellites, an antenna attached to the GPS receiver configured to convert the radio signals from the GPS satellites and convert to electrical signals, a USB port, a solar cell and rechargeable battery, an emergency beacon configured to send out radio signals, a processor housing enclosing the GPS receiver, GPS antenna, USB port, and solar cell and rechargeable battery, a modular tray configured to attach to the processor housing, storage space on the modular tray, multiple survival tools enclosed within the storage space on the modular tray including a fire starter kit, fishing kit, flash light, emergency strobe, animal deterrent spray, emergency cord, a multi-tool, and a tile tracker, a cover attached to the modular tray configured to keep the one or more survival tools within the storage space on the modular tray, a signal mirror and compass embedded within the cover, an attachment device connected to the processor to removably attach the processor unit and storage housing to a user's body, an attachment point on the attachment device for survival tools, and a secure workbox to hold the GPS receiver, GPS antenna, USB port, solar cell and rechargeable battery, emergency beacon, processor housing, modular tray, multiple survival tools, cover, and attachment device.

A wide variety of additional embodiments will be more readily understood and appreciated by referring to the following detailed description and accompanying drawings.

### BRIEF DESCRIPTION OF THE FIGURES

The following example embodiments are representative of exemplary techniques and structures designed to carry out the objectives of the present general inventive concept, but the present general inventive concept is not limited to these example embodiments. Moreover, in the accompanying drawings and illustrations, the sizes and relative sizes, shapes, and qualities of lines, entities, and regions may be exaggerated for clarity, in which:

FIG. 1 is a perspective view of an emergency lifesaving device, according to an example embodiment of the present general inventive concept;

FIG. 2 is a perspective view of an emergency lifesaving device, according to an example embodiment of the present general inventive concept;

FIG. 3 is a perspective view of a processor unit of an emergency lifesaving device, according to an example embodiment of the present general inventive concept;

FIG. 4 is a perspective view of an emergency lifesaving device with attachable housing unit, according to an example embodiment of the present general inventive concept;

FIG. 5 is a perspective view of an emergency lifesaving device with attachable housing unit, according to an example embodiment of the present general inventive concept;

FIG. 6 is a perspective view of an emergency lifesaving device with attachable housing unit, according to an example embodiment of the present general inventive concept;

FIG. 7 is a perspective view of an emergency lifesaving device with attachable housing unit, according to an example embodiment of the present general inventive concept;

FIG. 8 is a view of an emergency lifesaving device attached to a child, according to an example embodiment of the present general inventive concept;

FIG. 9 is a view of an emergency lifesaving device attached to a pet, according to an example embodiment of the present general inventive concept;

FIG. 10 is a perspective view of an emergency lifesaving device workbox according to an example embodiment of the present general inventive concept;

FIG. 11 is a perspective view of an emergency lifesaving device enclosed within a workbox, according to an example embodiment of the present general inventive concept.

### DETAILED DESCRIPTION

Reference will now be made to the example embodiments of the present general inventive concept, examples of which are illustrated in the accompanying drawings and illustrations. The example embodiments are described herein in order to explain the present general inventive concept by referring to the figures.

Note that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. Spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Although example embodiments the present general inventive concept will be particularly described as being applied to a wrist watch type device, it will be appreciated that the present general inventive concept can be applied to a variety of other objects, for example a hand-held unit, a belt attachment, etc.

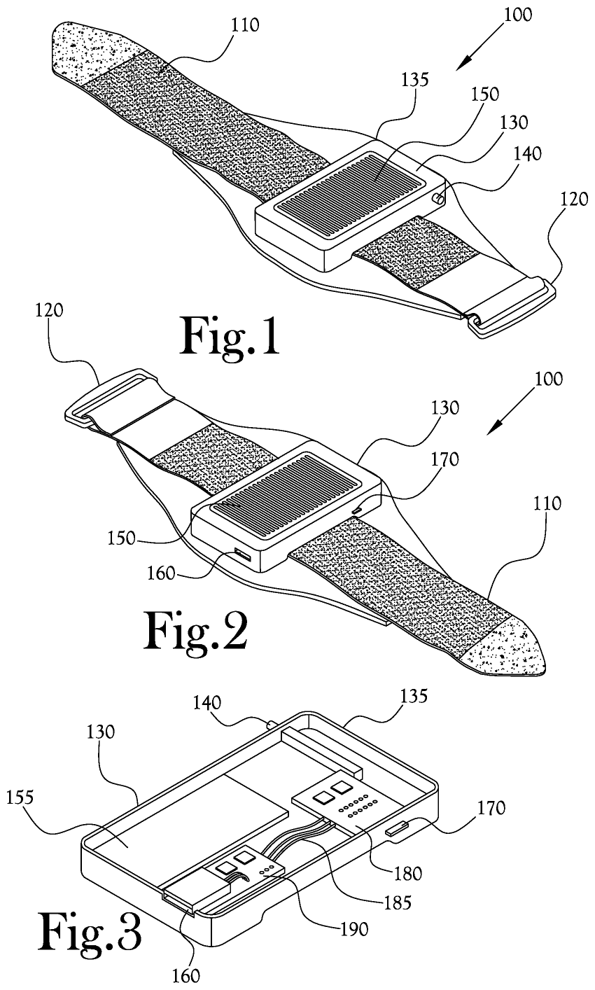

Referring to FIG. 1, example embodiments of the present general inventive concept can be implemented in connection with an emergency lifesaving device for sending and receiving data regarding location information as well as providing storage space for multiple survival tools. As illustrated in the example embodiment of FIG. 1, emergency lifesaving device 100 is shown with an attachment device 110 to attach the emergency lifesaving device 100 to a user's body. The attachment device 110 may comprise an adjustable band configured to clasp around a user's appendage. As shown in FIG. 1, the adjustable band may have a Velcro hook surface on one face of the adjustable band, which slides through a clasp 120 and attaches to a Velcro loop surface on another face of the adjustable band, in order to facilitate adjustment of the attachment device 110 to the user's body. In another embodiment of the invention, the adjustable band may have a buckle and prong to facilitate adjustment of the attachment device 110 to the user's body.

Also illustrated in the example embodiment of FIG. 1, the emergency lifesaving device 100 is shown with a processor unit 130 which may be attached to the attachment device 110. The processor unit 130 may include a processor housing 135, as shown, which holds the various components of the processor unit 130. The processor housing 135 may include an opening (on its underside as shown in FIG. 1) to accept the attachment device 110. The processor unit 130 may also include, as described in subsequent sections below, a GPS receiver which is configured to receive location information from multiple GPS satellites and calculate location of the GPS receiver based on a distance from the GPS satellites, a GPS antenna 140 attached to the GPS receiver and configured to convert radio signals from the GPS satellites to electrical signals which can be processed by the GPS receiver, a solar power supply including a solar cell 150, shown on the face of the processor housing 135, and rechargeable battery, and an emergency beacon configured to send out radio signals. All such configurations and modifications are intended to be included within the scope and spirit of the present general inventive concept.

FIG. 2 is an alternative view of the emergency lifesaving device 100 of FIG. 1. In this view can be seen a USB port 160 which may be used to provide electrical power for a cell phone or other device. Power to the emergency lifesaving device 100 may be provided by the solar power supply including the solar cell 150, shown on the face of the processor housing 135, and rechargeable battery. The emergency lifesaving device 100 may also provide slots for standard batteries in the case where the rechargeable battery has run out of power and/or there is insufficient sunlight to charge the solar cell 150. Also shown in FIG. 2 is the activation button 170 for the emergency beacon which is configured send out radio signals to indicate to listeners the position of the emergency lifesaving device 100. In other embodiments, the emergency beacon could be programmed to send out radio signals in the event specified criteria have been met, such as environmental conditions or user defined time durations.

FIG. 3 shows an inside view the processor housing 135 of the processor unit 130 to reveal its component parts. The GPS antenna 140 may extend through the processor housing 135 and be connected to the GPS receiver, which may be part of a printed circuit board 180. Also shown in FIG. 3 is the activation button 170 for the emergency beacon. An additional printed circuit board 190 is shown which may control the USB port 160. A rechargeable battery 155 may be provided which stores the electrical charge from the solar cell 150 which is shown in FIGS. 1 and 2. The emergency lifesaving device 100 may also provide slots for standard batteries in the case where the rechargeable battery has run out of power and/or there is insufficient sunlight to charge the solar cell 150 Although not shown in the image, an electrical connection is provided between the rechargeable battery 155 and the other devices within the processor housing 135 in order to provide electrical power to these devices. Additionally, an electrical connection 185 is shown between the two printed circuit boards 180 and 190, which may be used, for example, to input data from the USB port 160 to the emergency beacon or from the GPS receiver to the USB port 160. The particular electronics configuration discussed in this paragraph is for illustrative purposes and is not intended to be limiting, however, and a person of ordinary skill in the art would appreciate that other configurations are possible within the scope of the invention.

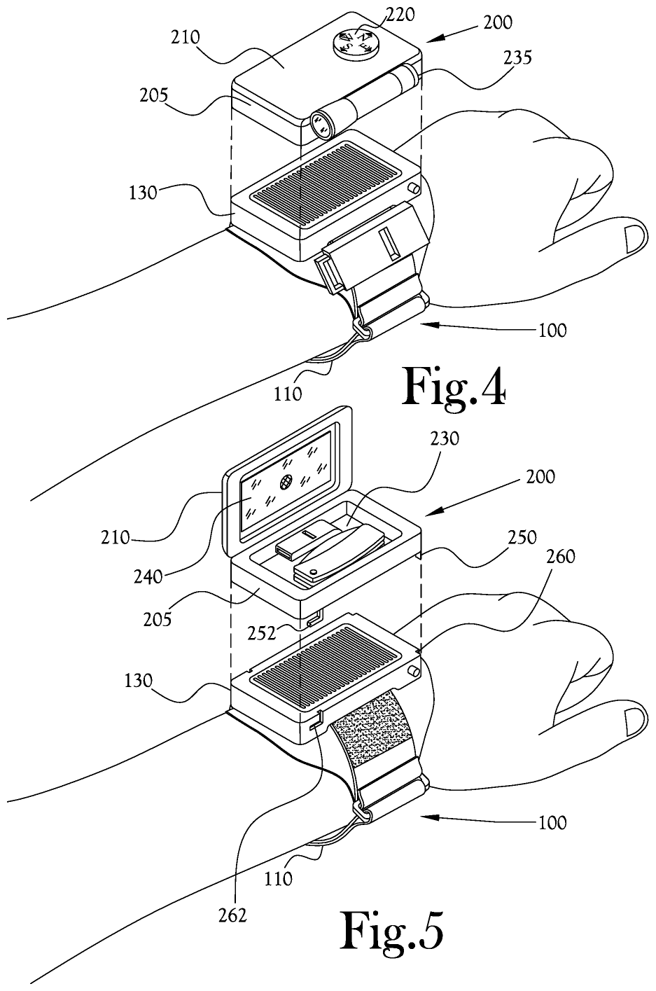

FIG. 4 shows a perspective view of a storage housing 200 which may be removably attachable to the processor unit 130. The storage housing 200 may contain a modular tray 205, a cover 210 attached to the modular tray 205, and storage space 230 (shown in FIG. 5) within the modular tray 205, which may have sufficient space to hold one or more survival tools. The storage housing 200 may also provide for one or more attachments points 235 to hold one ore more survival tools on the outside of the modular tray 205, for example a small flashlight, as shown in FIG. 4. These attachment points on the outside of the modular tray 205 may be for example with Velcro, or other attachment devices known in the art. A compass 220 may be attached to, or embedded within the face of the cover 210 of the storage housing 200 which can be used to assist with navigation. Also shown in FIG. 4 is a survival tool, for example a whistle, shown secured to the attachment device 110. The survival tool can be secured to the attachment device 110 with Velcro, or other attachment devices known in the art. To secure the storage housing 200 to the processor unit 130, a magnet (not shown in the image) may be provided. Other techniques for securing the storage housing 200 to the processor unit 130 are described below.

FIG. 5 shows an additional perspective view of a storage housing 200 which is removably attachable to the processor unit 130, with the cover 210 in an open position. The storage housing 200 may contain a modular tray 205 and storage space 230 within the modular tray 205, which may have sufficient space to hold one or more survival tools, for example a whistle and pocket knife. Multiple other survival tools may be stored within the storage space 230, including, but not limited to a fire starter kit, fishing kit, flash light, emergency strobe, animal deterrent spray, emergency cord, tile tracker and a multi-tool. Embedded within the inside of the cover 210 of the storage housing 200 is a signal mirror. To secure the storage housing 200 to the processor unit 130, a straight tab 250 and angled tab 252 may reside on the storage housing 200 and a straight slot 260 and angled slot 262 may reside on the storage housing 200, with the tabs 250 and 252 inserted within the corresponding slots 260 and 262 to produce a secure enclosure. Additionally, the tabs 250 and 252 may reside on the processor unit 130 and the slots 260 and 262 may reside on the storage housing 200. Many other attachment devices and methods known in the art may be provided for securing the storage housing 200 to the processor unit 130 that fall within the scope of this invention.

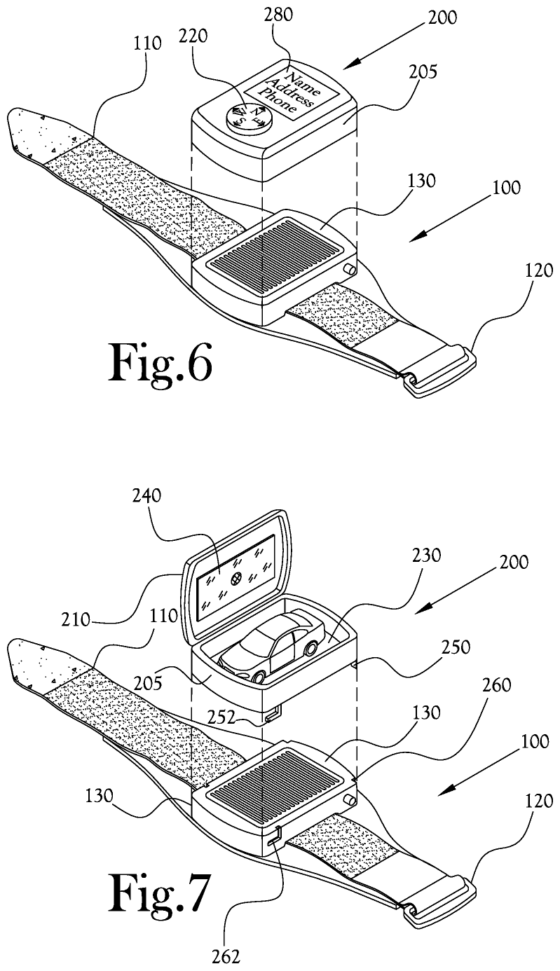

FIG. 6 is a perspective view of an alternative embodiment of the emergency lifesaving device 100 of FIG. 1. In this view can be seen the processor unit 130 and a storage housing 200 which may contain a modular tray 205. In this embodiment, the emergency lifesaving device 100 may be used by a child who may not need all the same features, or may want different features as may be required by an adult. In addition to the compass 220 which may be attached or embedded within the face of the cover 210 of the storage housing 200, an address and/or contact information label 280 may also be provided on the face of the cover 210 of the storage housing 200. FIG. 7 shows an additional perspective view of FIG. 6, including a storage housing 200 which is removably attachable to the processor unit 130, with the cover 210 in an open position. The storage housing 200 may contain a modular tray 205 and storage space 230 within the modular tray 205, which may have sufficient space to hold one or more children's toys, for example a toy car. To secure the storage housing 200 to the processor unit 130, a straight tab 250 and angled tab 252 may reside on the storage housing 200 and a straight slot 260 and angled slot 262 may reside on the storage housing 200, with the tabs 250 and 252 inserted within the corresponding slots 260 and 262 to produce a secure enclosure. Additionally, the tabs 250 and 252 may reside on the processor unit 130 and the slots 260 and 262 may reside on the storage housing 200. Many other attachment devices and methods know in the art may be provided for securing the storage housing 200 to the processor unit 130 that fall within the scope of this invention.

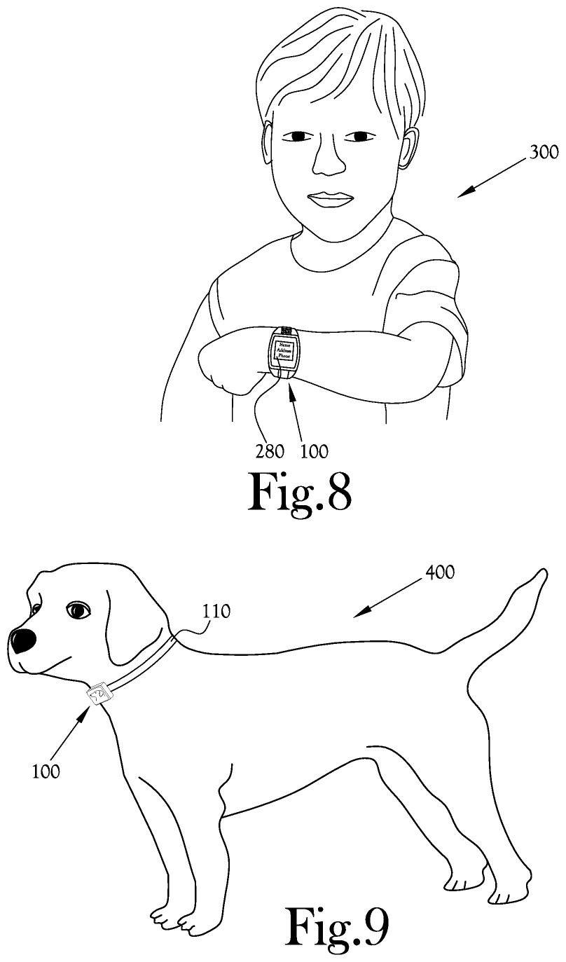

FIG. 8 shows an image of a child 300 wearing the emergency lifesaving device 100. In this figure, the emergency lifesaving device 100 is worn on the user's arm. An address and/or contact information label 280 may also be provided on the face of the cover 210 of the storage housing 200. The storage housing 200 may contain a modular tray 205 and storage space 230 within the modular tray 205, which may have sufficient space to hold one or more children's toys.

FIG. 9 shows an image of a pet 400 wearing the emergency lifesaving device 100. Use of the emergency lifesaving device 100 with a pet may require different features than may be required by a human user. In this figure, the emergency lifesaving device 100 is worn around the user's neck. In this instance, the attachment device 110 may be a pet collar. An address and/or contact information label 280 may also be provided on the face of the cover 210 of the storage housing 200. The storage housing 200 may contain a modular tray 205 and storage space 230 within the modular tray 205, which may have sufficient space to hold one or more treats, or other pet products. Additionally, the emergency lifesaving device 100 may include an emergency beacon which could be programmed to send out radio signals periodically or in the event specified criteria have been met, such as environmental conditions or user defined time durations. Additionally, power to the emergency lifesaving device 100 may be provided by a solar power supply including a solar cell 150 on the face of the processor housing 135, and a rechargeable battery. The emergency lifesaving device 100 may also provide one or more slots for standard batteries in the case where the rechargeable battery has run out of power and/or there is insufficient sunlight to charge the solar cell 150.

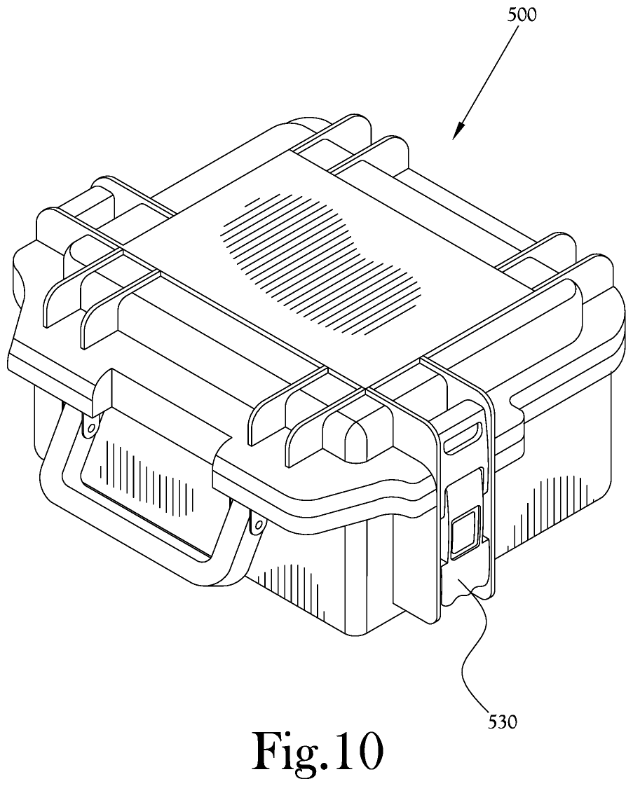

FIG. 10 shows a secure workbox 500 which may be used to store the emergency lifesaving device 100 and its various components 540. The secure workbox 500 may be secured by a latch system 530. The secure workbox 500 may be made of a variety of different materials that are strong, impact-resistant, waterproof, and relatively lightweight, including rigid plastic, aluminum, carbon, titanium, etc.

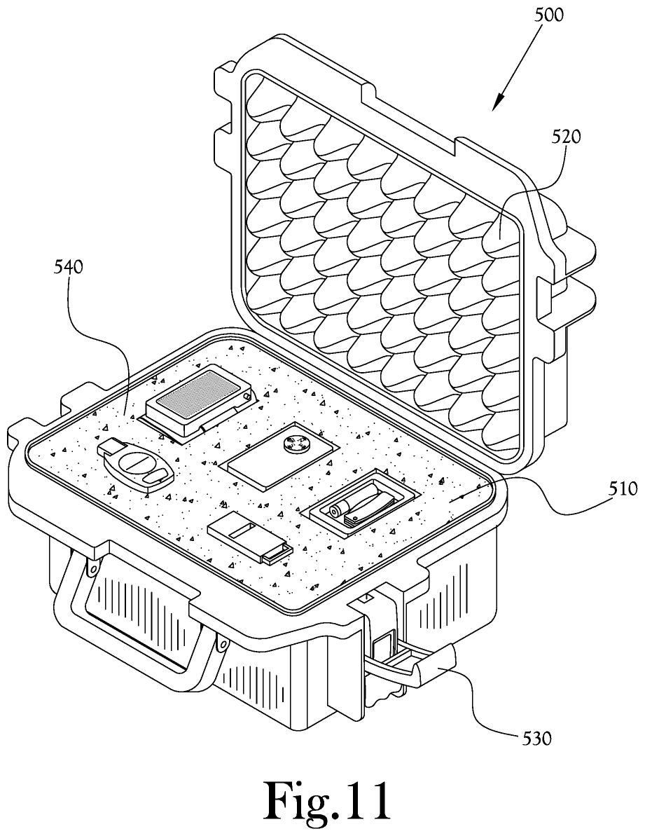

FIG. 11 shows a secure workbox 500 which may be used to store the emergency lifesaving device 100 and its various components 540, in an open position. The secure workbox 500 may be secured by a latch system 530. To prevent the various components 540 from moving about while in transit, a foam padding with cutouts 510 that are sized for each of the various components 540 may be provided. Additionally, egg crate foam 520 may be provided in the top of the secure workbox 500 to further provide a secure fit.

It is noted that the simplified diagrams and drawings do not illustrate all the various connections and assemblies of the various components, however, those skilled in the art will understand how to implement such connections and assemblies, based on the illustrated components, figures, and descriptions provided herein, using sound engineering judgment.

Numerous variations, modifications, and additional embodiments are possible, and accordingly, all such variations, modifications, and embodiments are to be regarded as being within the spirit and scope of the present general inventive concept. For example, regardless of the content of any portion of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated.

While example embodiments have been illustrated and described, it will be understood that the present general inventive concept is not intended to limit the disclosure, but rather it is intended to cover all modifications and alternate devices and methods falling within the spirit and the scope of the invention as defined in the appended claims.

1. An emergency device, comprising:
a processing unit configured to provide a GPS location of a user, the processing unit including a source of electrical power to provide a source of electrical power to the processing unit and one or more external devices;
a storage housing removably attachable to the processing unit, the storage housing being configured to store one or more survival tools therein; and
an attachment device connected to the processing unit such that the processing unit is removably attachable to the user's body.

2. The emergency device of claim 1, wherein the processing unit comprises:
a processor housing;
an opening within the processor housing to receive the attachment device;
a GPS receiver configured to receive location information from multiple GPS satellites and calculate location of the GPS receiver based on a distance from the GPS satellites;
an antenna attached to the GPS receiver configured to convert radio signals from the GPS satellites and convert the radio signals to electrical signals;
a USB port;
a solar power supply; and
an emergency beacon configured to send out radio signals.

3. The emergency device of claim 2, wherein the emergency beacon is configured to send out radio signals based on activation by depressing a button.

4. The emergency device of claim 2, wherein the solar power supply comprises:
a rechargeable battery; and
a solar cell configured to receive energy from the sun and to provide electrical charge to the rechargeable battery.

5. The emergency device of claim 1, wherein the storage housing comprises:
a modular tray;
storage space on the modular tray; and
a cover attached to the modular tray configured to keep the one or more survival tools within the storage space on the modular tray.

6. The emergency device of claim 5, wherein the modular tray includes a magnet to securely attach the modular tray to the processor housing.

7. The emergency device of claim 5, wherein the modular tray includes a rail configured to attach to a notch on the processor housing to securely attach the modular tray to the processor housing.

8. The emergency device of claim 5, wherein the modular tray includes a protrusion configured to snap into an opening in the processor housing to securely attach the modular tray to the processor housing.

9. The emergency device of claim 7, wherein the cover attached to the modular tray includes a compass embedded in the cover.

10. The emergency device of claim 8, wherein the cover attached to the modular tray includes a signal mirror embedded in the cover.

11. The emergency device of claim 8, wherein the modular tray includes a fire starter kit, fishing kit, flash light, emergency strobe, animal deterrent spray, emergency cord, and a multi-tool.

12. The emergency device of claim 1, wherein the attachment device comprises an adjustable band configured to clasp around a user's appendage.

13. The emergency device of claim 12 wherein the adjustable band includes an attachment point for survival tools.

14. The emergency device of claim 12 wherein the attachment point comprises a Velcro patch.

15. The emergency device of claim 12 wherein the attachment point comprises a clip.

16. The emergency device of claim 12 wherein the adjustable band includes a buckle and prong to adjust a length of the band around the user's appendage.

17. The emergency device of claim 12 wherein the adjustable band uses a Velcro closure to adjust a length of the band around the user's appendage.

18. An emergency kit, comprising:
a GPS receiver configured to receive location information from multiple GPS satellites and calculate location of the GPS receiver based on a distance from the GPS satellites;
an antenna attached to the GPS receiver configured to convert the radio signals from the GPS satellites and convert to electrical signals;
a USB port;
a solar cell and rechargeable battery;
an emergency beacon configured to send out radio signals;
a processor housing enclosing the GPS receiver, GPS antenna, USB port, and solar cell and rechargeable battery;
a modular tray configured to attach to the processor housing;
storage space on the modular tray;
multiple survival tools enclosed within the storage space on the modular tray including a fire starter kit, fishing kit, flash light, emergency strobe, animal deterrent spray, emergency cord, a multi-tool, and a tile tracker;
a cover attached to the modular tray configured to keep the one or more survival tools within the storage space on the modular tray;
a signal mirror and compass embedded within the cover;
an attachment device connected to the processor housing to removably attach the processor unit and storage housing to a user's body;
an attachment point on the attachment device for survival tools; and
a secure workbox to hold the GPS receiver, GPS antenna, USB port, solar cell and rechargeable battery, emergency beacon, processor housing, modular tray, multiple survival tools, cover, and attachment device.

19. The emergency kit of claim 18 including a display on the processor housing to display location data processed by the GPS receiver.

20. The emergency kit of claim 18 wherein the GPS receiver is configured to communicate with the user's cell phone.
